(19) United States
(12) Patent Application Publication
(10) Pub. No.: US 2003/0055687 A1
(43) Pub. Date: Mar. 20, 2003

(54) Method and system of providing medical goods and services to consumers through retail outlets

(76) Inventor: Alan T. Rudy, Columbus, OH (US)

Correspondence Address: Porter, Wright, Morris & Arthur LLP, ATTN: Intellectual Property Department, 28th Floor, 41 South High Street, Columbus, OH, 43215-6194, US

(21) Appl. No.: 09/954,939

(22) Filed: Sep. 17, 2001

(51) Int. Cl. G06F 17/60

(52) U.S. Cl. 705/4; 705/2

(57) ABSTRACT

A method of providing medical goods and services to consumers includes the steps of a retail outlet receiving a request for medical goods and services from a consumer who is present at the retail outlet. The retail outlet verifying, through a benefit manager, the consumer's current eligibility for health benefits from Medicare or other health insurance provider for the medical goods. The verification is preferably performed over a PBM computer system. An assignment of benefits is obtained from the consumer and transferred to the benefit manager by the retail outlet wherein the consumer assigns his or her rights to Medicare or other health insurance benefits to the benefit manager, including the right to submit a claim for reimbursement and the right to receive payment directly from Medicare or such other health insurance payer for the medical goods and services. If eligible and authorized by a physician's order, the retail outlet provides the needed medical goods and services to the consumer. The medical goods dispensed to the consumer by the retail outlet are either owned by the benefit manager, owned by the retail outlet and transferred to the benefit manager just prior to the release of the medical goods to the consumer, or owned by the retail outlet. The benefit manager completes a complicated Medicare claim form and/or other health insurance claim form based on the medical goods and services provided to the consumer, then submits such claim to Medicare and/or the other health insurance payer for reimbursement. If the claim is clean and proper, the benefit manager receives reimbursement from Medicare and/or the other health insurance payer after a period of time. The benefit manager makes a fixed, periodic payment to the retail outlet for services rendered by the retail outlet on behalf of the benefit manager.

### CROSS-REFERENCE TO RELATED APPLICATIONS

Not Applicable

### STATEMENT REGARDING FEDERALLY SPONSORED RESEARCH

Not Applicable

### REFERENCE TO MICROFICHE APPENDIX

Not Applicable

### FIELD OF THE INVENTION

The present invention generally relates to an improved method and system of providing medical goods and services to consumers through retail outlets, typically retail pharmacies, and, more particularly, to such a method and system wherein consumers can receive their necessary medical goods and services at the retail outlet immediately, without delay, with no up-front payment required and little to no out-of-pocket expenses and, without having to subsequently (i) complete a complicated Medicare claim form and/or other health insurance claim form; (ii) file a claim with Medicare or other health insurance payer; (iii) wait weeks or months for reimbursement of money already paid or (iv) risk denial or rejection of such claim having already paid the money up-front for the medical goods and services.

### BACKGROUND OF THE INVENTION

Currently when a consumer needs medical goods and services such as, for example, durable medical equipment and supplies and related items, like diabetes testing supplies, the consumer can go to a retail outlet, such as a pharmacy, and receive the medical goods and services immediately, without delay. However, the retail outlet requires full payment up-front from the consumer at the time of the consumer's request for the medical goods and services before the retail outlet will provide the medical goods and services to the consumer. If the consumer is eligible for benefits from Medicare or other health insurance, the retail outlet may or may not provide instructions to the consumer that a claim may be submitted by the consumer for reimbursement of the money already paid by the consumer for the medical goods and services. Some retail outlets will provide a copy of a Medicare claim form to the consumer for the consumer to complete and some retail outlets will complete and mail (or electronically submit) a claim to Medicare for the consumer. Retail outlets are less likely to provide non-Medicare claim forms or to submit claims to non-Medicare health insurance for the consumer. In any event, the consumer must wait for any reimbursement which would be received through the mail from Medicare and/or the other health insurance payer. If such claim is denied or rejected, the consumer, if still desiring to obtain reimbursement, would need to modify and correct such claim and then re-file such claim, waiting even longer for any reimbursement. While the consumer immediately receives the desired medical goods and services from the retail outlet, the consumer must be able to put forth full payment up-front for the medical goods and services even if the medical goods and services are covered by Medicare and/or other health insurance plans. This can particularly be a problem when the medical goods and services must be obtained on a regular basis, such as is often required to treat chronic health conditions like diabetes, asthma, incontinence, etc.

An alternative currently available to the consumer, is to obtain medical goods and services via “mail order”. The consumer orders the medical goods and services from a supplier via mail, phone or the Internet. If the consumer assigns his or her right to Medicare or other health insurance benefits to the supplier, the consumer can receive the goods and services with no up-front payment. The consumer usually has a financial responsibility for a small portion (typically 20%) of the remaining allowable amount not paid by Medicare or other health insurance, and this small portion would be due at a later time than at the time the supplier mails the medical goods to the consumer. If the consumer has qualifying secondary or supplemental health insurance coverage for the medical goods and services, the consumer may receive the medical goods and services with no up-front payment required and no out-of-pocket expense (subject to any applicable annual deductible not covered by such secondary or supplemental health insurance). The supplier mails the medical goods to the consumer and files a claim for reimbursement with Medicare and/or any other health insurance payer. This system is particularly good when the medical goods and services are needed on a regular basis. However, there can be a problem if the consumer is in short supply of needed medical goods for some reason because it takes some time for the medical goods to be received by the consumer once an order for such medical goods is placed with the supplier due to order processing and shipping time. Further, many consumers prefer to obtain their medical goods at a local retail outlet, typically retail pharmacies, due to the emotional and educational feedback the consumer can easily receive from a retail outlet representative, typically a pharmacist. Such emotional and/or educational feedback is not as easily obtained in the standard mail order context.

While these systems are adequate to supply medical goods to consumers, they each have limitations such as relatively large up-front financial payments required from the consumer by the retail outlet at the time of the consumer's request for the medical goods and services, out-of-pocket expenses for the consumer and long lead times on the receipt by the consumer of the mail-order delivery of needed medical goods. Accordingly, there is a need in the art for an improved method and system for providing medical goods and services to consumers. Particularly advantageous would be a system having no up-front financial payments required from the consumer by the retail outlet at the time of the consumer's request for the medical goods and services, little or no out-of-pocket expenses or paperwork for the consumer and no lead times on the receipt by the consumer of the needed medical goods.

### SUMMARY OF THE INVENTION

The present invention provides a method and system of providing medical goods and services to consumers that overcomes at least some of the above-noted problems of the related art. According to the present invention, a method of providing medical goods and services to consumers through retail outlets includes the step of verifying current eligibility of a consumer for benefits from a health benefit provider for medical goods and services desired by the consumer. The current eligibility of the consumer is verified while the consumer is present at a retail outlet. An assignment from the consumer to a benefit manager is received that assigns all rights to the benefits from the health benefit provider for medical goods dispensed to the consumer. The retail outlet and the benefit manager are separate entities. A claim to the health benefit provider is completed and submitted for reimbursement for the medical goods dispensed to the consumer. Reimbursement is received from the health benefit provider for the medical goods dispensed to the consumer. A fixed, periodic payment is paid to the retail outlet by the benefit manager for services rendered to the consumer by the retail outlet on behalf of the benefit manager.

According to another aspect of the present invention, a method of providing medical goods and services to consumers includes the steps of obtaining eligibility information from a consumer who is presently located at a retail outlet and who desires immediate medical goods and services and forwarding the eligibility information to a benefit manager for verification of the consumer's eligibility for benefits from a health benefit provider for the medical goods and services. The benefit manager is a separate entity from the retail outlet. The consumer is directed to make an assignment of the benefits to the benefit manager for the medical goods and services. If eligible, the retail outlet preferably provides the medical goods and services to the consumer while the consumer is present at the retail outlet and requests the medical goods and services. Evidence of the assignment is forwarded from the retail outlet to the benefit manager. The retail outlet receives a fixed, periodic payment from the benefit manager for services rendered by the retail outlet on behalf of the benefit manager.

From the foregoing disclosure and the following more detailed description of various preferred embodiments it will be apparent to those skilled in the art that the present invention provides a significant advance in the technology and art of providing medical goods and services to consumers. Particularly significant in this regard is the potential the invention affords for providing a uniquely convenient and low or no out-of-pocket cost way, with no up-front financial payment required, for consumers to immediately obtain medical goods and services and a way for retail outlets to maintain consumer traffic in their stores, to increase consumer traffic in their stores and to increase purchases by consumers of items other than the medical goods and services obtained through this invention due to the fact that the consumer would have more money in his or her pocket than if he or she had to pay up-front for the medical goods and services obtained through this invention. Additional features and advantages of various preferred embodiments will be demonstrated via the detailed description provided below.

### BRIEF DESCRIPTION OF THE DRAWINGS

These and further features of the present invention will be apparent with reference to the following description and drawings, wherein:

FIG. 1 is a diagrammatic view of a method and system for providing medical goods and services to consumers through retail outlets according a first embodiment of the present invention;

FIG. 1A is a diagrammatic view of a variation of the method and system of FIG. 1;

FIG. 2 is a diagrammatic view of a method and system for providing medical goods and services to consumers through retail outlets according a second embodiment of the present invention;

FIG. 2A is a diagrammatic view of a variation of the method and system of FIG. 2;

FIG. 3 is a diagrammatic view of a method and system for providing medical goods and services to consumers through retail outlets according a third embodiment of the present invention;

FIG. 3A is a diagrammatic view of a variation of the method and system of FIG. 3; and

FIG. 4 is a diagrammatic view of a method and system for providing medical goods and services to consumers through retail outlets according a fourth embodiment of the present invention.

### DETAILED DESCRIPTION OF CERTAIN PREFERRED EMBODIMENTS

It will be apparent to those skilled in the art, that is, to those who have knowledge or experience in this area of technology, that many uses and variations are possible for the improved method and system of providing medical goods and services through retail outlets, typically retail pharmacies. The following detailed discussion of various alternative and preferred embodiments will illustrate the general principles of the invention with reference to providing durable medical equipment and supplies, and related items, and prescription drugs, and services, to end user consumers. Other embodiments suitable for other applications will be apparent to those skilled in the art given the benefit of this disclosure.

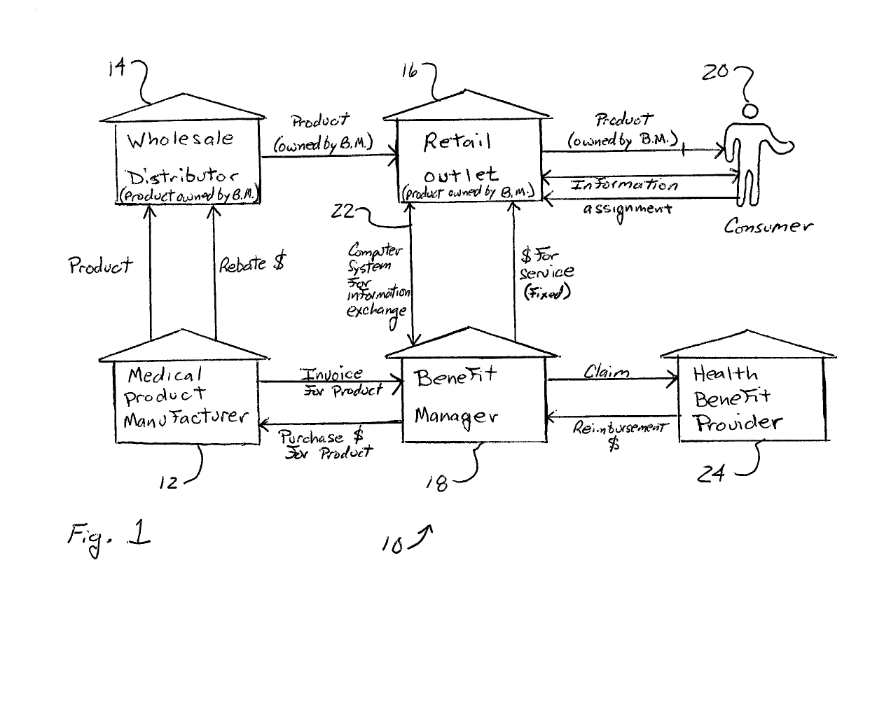

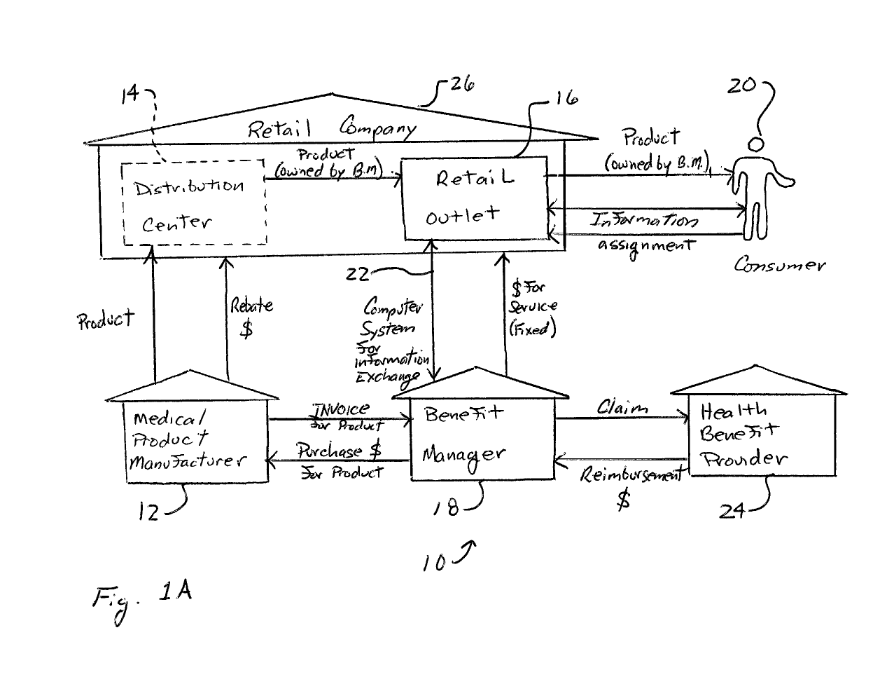

Referring now to the drawings, FIG. 1 diagrammatically shows a system 10 for providing medical products or goods and related services to consumers through retail outlets according to a first embodiment of the present invention. The illustrated system 10 includes a medical product manufacturer 12, a wholesale distributor 14, at least one retail outlet 16, and a benefit manager 18. The medical product manufacturer 12 produces and/or obtains the medical goods to be sold and ships a desired quantity to the wholesale distributor 14. Preferably, the medical product manufacturer 12 does not invoice the wholesale distributor 14 for the shipped medical goods but instead sends the invoice directly to the benefit manager 18. As a result of the drop-shipment, the wholesale distributor 14 obtains possession of the medical goods on behalf of the benefit manager 18 which holds title to the medical goods. Preferably, the medical product manufacturer 12 also sends a product rebate to the wholesale distributor 14 relating to the medical goods shipped to the wholesale distributor 14. It is noted, however, that any rebate can alternatively be sent to the benefit manager 18 whereupon the wholesale distributor 14 is compensated for its services in different manner such as, for example, a payment sent to the wholesale distributor 14 from the benefits manager 18.

The wholesale distributor 14 ships desired quantities of the medical goods to the retail outlet 16 on behalf of the benefit manager 18. The retail outlet 16 is typically a retail pharmacy but can alternatively be another type of retail outlet. It is noted that while the illustrated system 10 shows only one retail outlet 16, there is typically a large plurality of retail outlets 16. With the medical goods located at the retail outlet 16, the medical goods are ready to be provided to consumers 20 as needed and as ordered by such consumer's treating physician office in accordance with Medicare and other applicable health insurance laws, rules, regulations and guidelines. Ownership of the medical goods rests with the benefit manager 18 until the consumer receives 20 such medical goods while present at the retail outlet 16.

When a consumer 20 desires to obtain medical goods and services, he or she travels to the retail outlet 16 and indicates his or her desire to obtain particular medical goods and services, provides a card or other documentation or information indicating that he or she is entitled to health benefits including such medical goods and services, and provides any necessary prescriptions, physician orders or other required documentation. The retail outlet 16 or the consumer 20, manually, via telephone, electronically or otherwise verifies with the benefit manager 18 that the consumer 20 is entitled to applicable health benefits under a program plan of a health benefit provider 24 such as, for example, Medicare and/or a health insurance company. The verification is preferably performed via a pharmacy benefits management (PBM) or other computer system 22. The PBM computer system 22 preferably links the benefit manager 18 and all of the retail outlets 16 of the system 10 for near real time communication, eligibility determination and product authorization. Preferably, the retail outlet 18 submits a request to the benefit manager 18 via the computer system 22 for authorization to supply goods to the consumer 20, the benefit manager 18 verifies that the consumer 20 is currently eligible for benefits from the health benefit provider 24 for the goods requested by the consumer 20, and, if appropriately verified, the benefit manager 18 provides the retail outlet 16 with a verification of eligibility and authorization to supply goods via the computer system 22.

If the consumer 20 is verified as a being entitled to applicable benefits, the retail outlet 16 directs the consumer 20 make an assignment to the benefit manager 18 of all of his or her benefits with regard to the requested medical goods. The assignment of benefits is typically made by the consumer 20 via traditional paper forms or via electronic forms, but may be made in another manner, such as verbally with appropriate recording. The assignment preferably includes all rights to submit a claim to the health benefit provider 24 for reimbursement and all rights to directly receive reimbursement from the health benefit provider 24. Once the consumer executes the assignment, the retail outlet 16 provides the consumer 20 with the desired and authorized medical goods and services on behalf of the benefits manager 18. The retail outlet 16 sends either copies or the originals of the assignment of benefits documentation, if any, and other information, along with any prescription forms, physician orders or other medical necessity documentation to the benefit manager 18, preferably via the PBM computer system 22.

The benefit manager 18 completes a complicated claim form, such as a Medicare claim form and/or other health insurance claim form, based on the medical goods and services provided to the consumer 20 and submits such claim to the health benefit provider 24 for reimbursement. In response, the health benefit provider 24 reviews and evaluates the documentation and information submitted for accuracy and sufficiency and, if allowed and the claim is clean and proper, sends reimbursement directly to the benefit manager 18 after a period of time. The benefit manager 18 sends payment to the medical product manufacturer 12 to satisfy the invoice for the medical goods and sends a separately agreed upon fixed, periodic payment to the retail outlet 16 for services rendered by the retail outlet 16 on behalf of the benefit manager 18. The fixed periodic payment for services is preferably made monthly but alternatively can be made at larger or smaller intervals. The benefit manager 18 can also obtain the consumer's share, if any, of the total charge for the medical goods and services directly from the consumer 20, or from such consumer's secondary or supplemental health insurance, if available. Alternatively, the consumer's share can be required to be paid by the consumer 20 directly to the retail outlet 16 at the time of obtaining the medical goods and services.

FIG. 1A illustrates a variation of the system 10 of FIG. 1 wherein the distributor 14 and the retail outlet 16 are related and/or part of a single retail company 26. It is also noted that that in either version of the system 10, the distributor 14 can be alternatively eliminated so that the medical goods are shipped directly to the retail outlet 16 from the medical product manufacturer 12.

This system 10 is particularly advantageous with medical goods and services like durable medical equipment and supplies and related items, such as, for example, diabetes testing supplies, because major medical billing is transformed into pharmacy-type billing. Diabetes testing supplies can include home blood glucose meters, lancing devices, test strips, control solutions, lancets, and insulin and syringes. It is noted that this system 10 can be utilized for any medical goods and services wherein the health benefit provider can make payment to a person or an entity other than the person or entity who dispenses the medical goods and services.

From the foregoing disclosure, it is apparent that the consumer 20 can conveniently and immediately, with no waiting for mail or other shipment delays, obtain desired medical goods and services when needed from a local retail outlet 16 with no up-front financial payment and little or no out-of-pocket expenses. It is also apparent that the retail outlet 16 has the benefits of maintaining current consumer traffic, increased consumer traffic, increased consumer spending of money in such retail outlet on items other than those obtained through this invention (due to the fact that the consumer 20 would have more money in his or her pocket than if he or she had to pay up-front for the medical goods obtained through this invention), a turnkey operation, and a system which is different but that operates like the generally familiar and existing prescription drug system (that is, a system that can translate major medical billing into prescription-type billing). It is further apparent that the medical product manufacturer 12 benefits from increased market share, a managed market share, the ability to drop-ship products, and the ability to preserve other aspects of regular and accepted course of dealings.

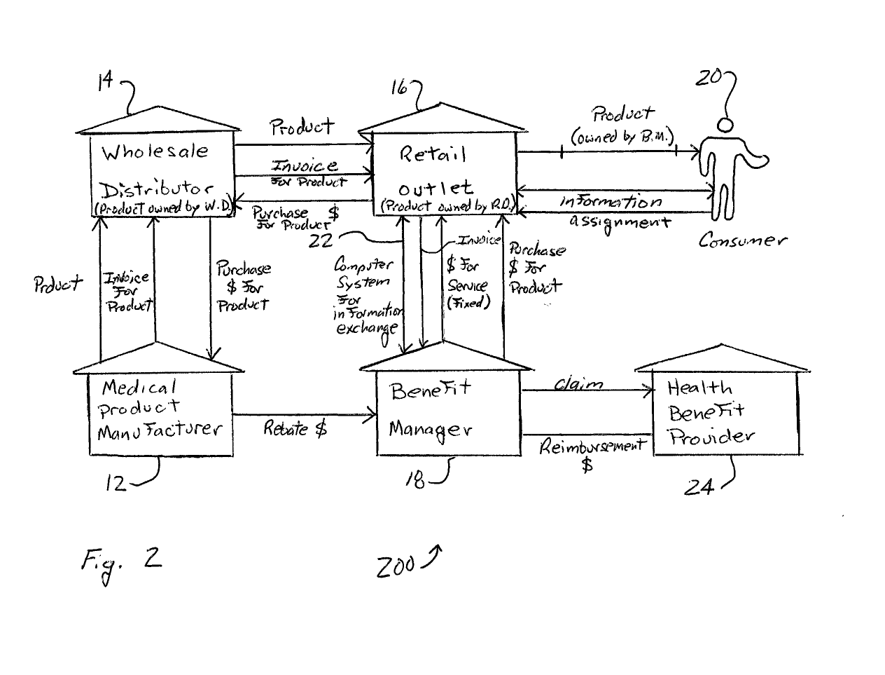

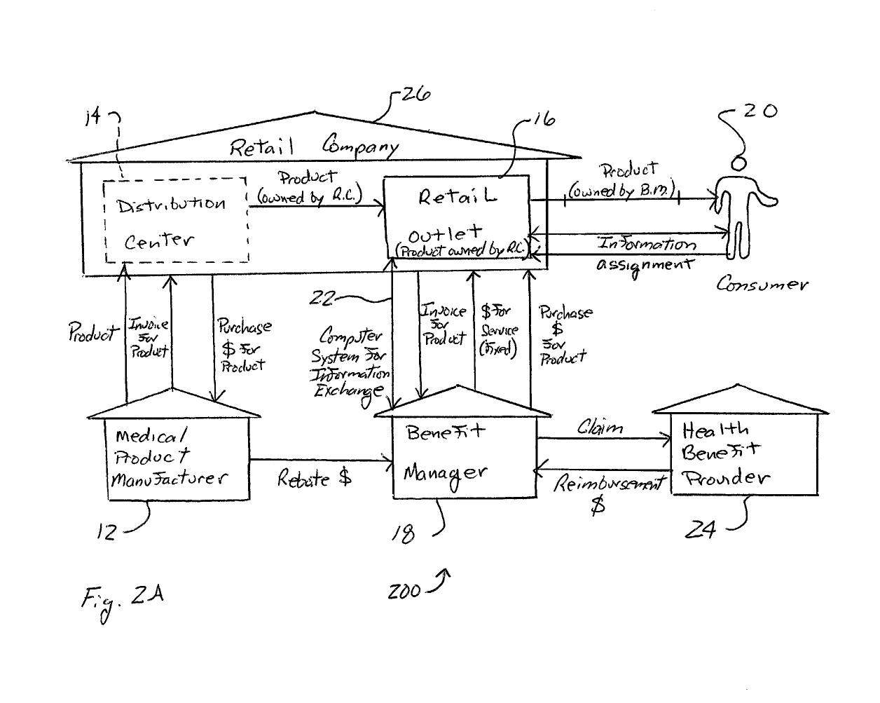

FIG. 2 diagrammatically shows a system 200 for providing medical goods and services to consumers through retail outlets according to a second embodiment of the present invention. The system 200 according to the second embodiment of the invention is substantially the same as the system 10 according to the first embodiment of the invention except as specifically noted hereinafter. The medical product manufacturer 12 again produces and/or obtains the medical goods to be sold and ships a desired quantity to the wholesale distributor 14. However, the medical product manufacturer 12 directly invoices the wholesale distributor 14 for the shipped medical goods. As a result, the wholesale distributor 14 has both possession and title to the medical goods. Preferably, the medical product manufacturer 12 sends any product rebate to the benefit manager 18 relating to the medical goods shipped to the wholesale distributor 14.

The wholesale distributor 14 ships desired quantities of the medical goods to the retail outlet 16. The wholesale distributor 14 directly invoices the retail outlet 16 for the shipped medical goods. As a result, the retail outlet has both possession and title to the medical goods. The medical goods remain the property of the retail outlet 16 until just prior to transfer to the consumer 20 whereupon ownership of the medical goods ready to be dispensed is transferred from the retail outlet 16 to the benefit manager 18 and then from the benefit manager 18 to the consumer 20. The retail outlet 16 preferably sends the benefit manager 18 an invoice for the medical goods sold to the benefit manager 18 and dispensed to the consumer 20 on behalf of the benefit manager 18. The benefit manager 18 sends payment to the retail outlet 16 to satisfy the invoice for the medical goods dispensed on behalf of the benefit manager 18 and sends the separately agreed upon fixed, periodic payment to the retail outlet 16 for services rendered by the retail outlet 16 on behalf of the benefit manager 18. The remainder of the system 200 is the same as described hereinabove with regard to the first embodiment of the invention.

FIG. 2A illustrates a variation of the system 200 wherein the distributor 14 and the retail outlet 16 are related and/or part of a single retail company 26. It is noted that that in either version of the system 200, the distributor 14 can be alternatively eliminated so that the medical goods are shipped directly to the retail outlet 16 from the medical product manufacturer 12. It is also noted that the system 200 according to the second embodiment has the same advantages as noted hereinabove with regard to the system 10 according to the first embodiment of the present invention.

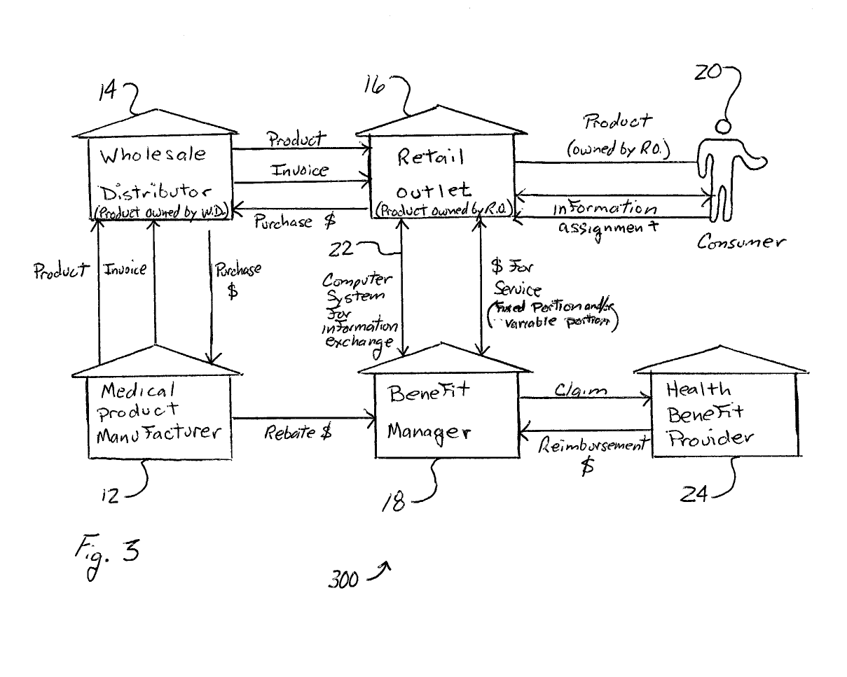

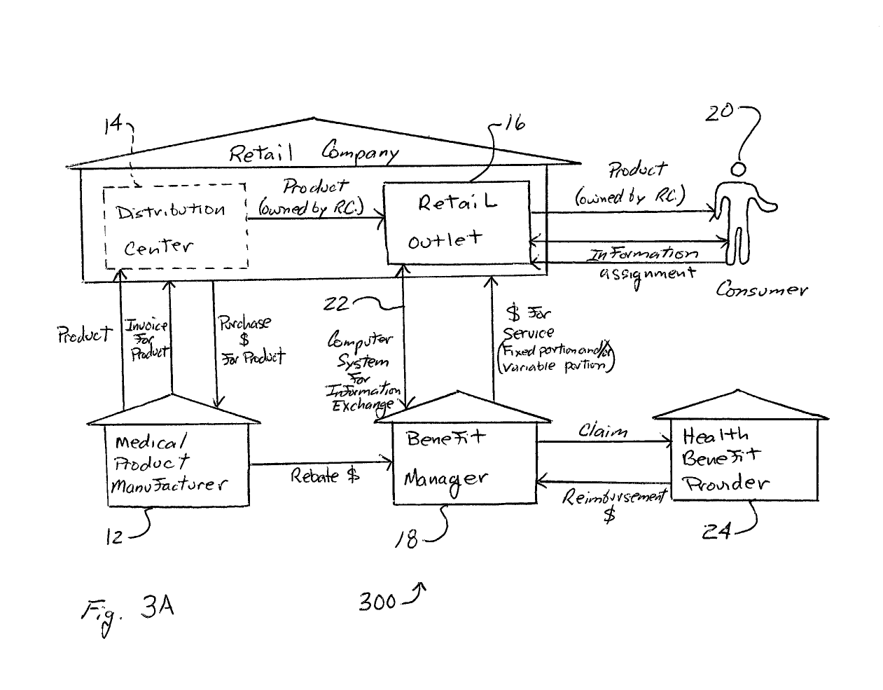

FIG. 3 diagrammatically shows a system 300 for providing medical goods and services to consumers through retail outlets according to a third embodiment of the present invention. The system 300 according to the third embodiment of the invention is substantially the same as the system 200 according to the second embodiment of the invention except as specifically noted hereinafter. Once the retail outlet obtains possession and title to the medical goods, the medical goods remain the property of the retail outlet 16 until transferred to the consumer 20. The benefit manager 18 does not own title to the medical goods at the time they are transferred to the consumer 20. The benefit manager 18 preferably sends the agreed upon fixed, periodic payment to the retail outlet 16 for services rendered by the retail outlet 16 and sends and a variable, periodic payment which varies depending on the quantity of medical goods dispensed under the system 300. Alternatively, the benefit manager 18 sends only the fixed, periodic payment or only the variable, periodic payment. The remainder of the system 300 is the same as described hereinabove with regard to the second embodiment of the invention.

FIG. 3A illustrates a variation of the system 300 wherein the distributor 14 and the retail outlet 16 are related and/or part of a single retail company 26. It is noted that that in either version of the system 300, the distributor 14 can be alternatively eliminated so that the medical goods are shipped directly to the retail outlet 16 from the medical product manufacturer 12.

The system 300 according to the third embodiment has the same advantages as noted hereinabove with regard to the systems 10, 200 according to the first and second embodiments of the present invention. The system 300 according to the third embodiment also has the advantage that the retail outlet 16 does not need a change its inventory management because the medical goods are owned and dispensed by the retail outlet 16.

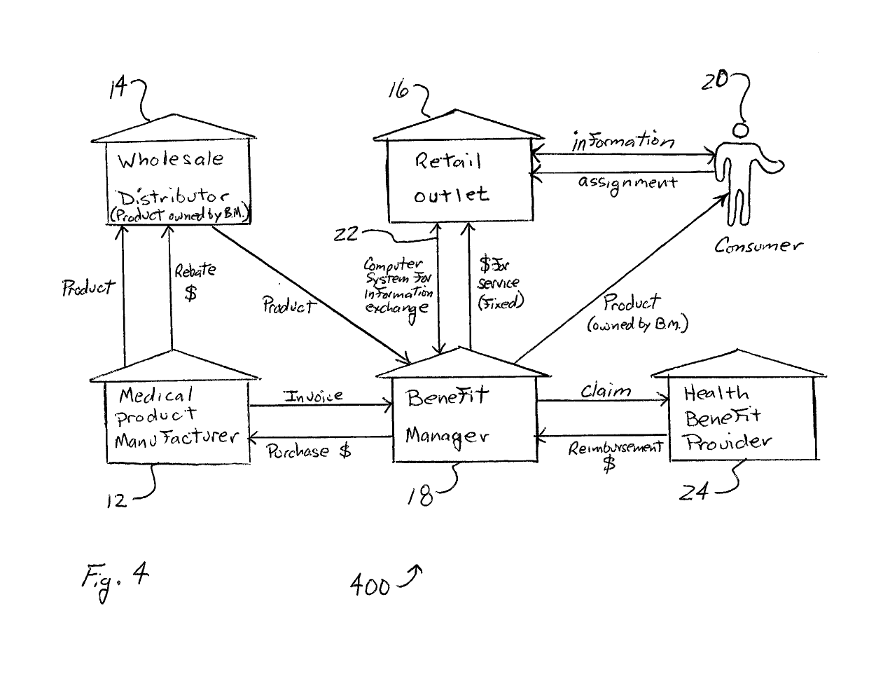

FIG. 4 diagrammatically shows a system 400 for providing medical goods and services to consumers through retail outlets according to a fourth embodiment of the present invention. The system 400 according to the third embodiment of the invention is substantially the same as the system 10 according to the first embodiment of the invention except as specifically noted hereinafter. The wholesale distributor 14 ships desired quantities of the medical goods directly to the benefit manager 18 rather than the retail outlet 16. With the medical goods located at the benefit manager 18, they are ready to be shipped to consumers 20 as needed.

When a consumer 20 desires to obtain medical goods and services he or she travels to their local retail outlet 16 and indicates his or her desire to obtain particular medical goods and services, provide a card indicating entitlement to applicable health benefits, and provides any necessary prescription forms, physician orders or other medical necessity documentation. The retail outlet 16 verifies the benefits with the benefit manager 18 as described hereinabove with regard to the first embodiment of the invention. If the consumer 20 is verified as eligible for applicable benefits, the retail outlet 16 obtains the assignment of the benefits from the consumer 20 as described hereinabove with regard to the first embodiment of the invention. The retail outlet 16 then informs the consumer 20 that the desired and authorized medical goods will be shipped to the consumer's home (or another identified shipping location) generally within a certain period of time (usually 7 to 10 calendar days).

The benefit manager 18 ships the desired medical goods directly to the consumer 20 via mail or other suitable courier within the desired period of time. The medical goods are received by the consumer 20 from the benefit manager 18 via an intermediary, e.g., United States Postal Service (first class or priority), package courier or recognized third party handler (like UPS or FedEx) or a retail outlet staff member, typically a retail pharmacist. The remainder of the system 300 is the same as described hereinabove with regard to the first embodiment of the invention.

This system is particularly advantageous with medical goods like prescription drugs such as, for example, respiratory medications, because the person or entity that dispenses the drugs must bill and receive reimbursement in his or her own name. However, it is noted that this system 400 can be utilized for any medical goods whether or not reimbursement for such medical goods must be made in the name of the entity that dispenses the medical goods.

From the foregoing disclosure of the system 400, it is apparent that the consumer 20 can conveniently order desired medical goods and services at a local retail outlet 16 with no up-front financial payment and little or no out-of-pocket expenses. It is also apparent that the retail outlet 16 has the benefits of maintaining current consumer traffic, increased consumer traffic, increased consumer spending of money in such retail outlet on items other than those obtained through this invention (due to the fact that the consumer 20 would have more money in his or her pocket than if he or she had to pay up-front for the medical goods obtained through this invention). It is further apparent that the medical product manufacturer 12 benefits from increased market share, a managed market share, the ability to drop-ship products, and the ability to preserve the incentive and rebate system.

It is noted that each of the features of the various embodiments disclosed herein can be utilized in combination with each of the other embodiments. For example, the system 400 of the fourth embodiment can be utilized such that the consumer 20 can easily and immediately receive goods and services at the retail outlet 16 like the first to third embodiments, if the claim is made to health benefit provider by the retail outlet 16 rather than the benefit manager 18. Under this variation, the benefit manager 18 preferably receives at least a portion of the rebate from the wholesale distributor 14.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A method of providing medical goods and services to consumers through retail outlets, said method comprising the steps of, in combination:
verifying current eligibility of a consumer for benefits from a health benefit provider for medical goods and services desired by the consumer;
wherein the current eligibility of the consumer is verified while the consumer is present at a retail outlet;
receiving an assignment from the consumer to a benefit manager that assigns all rights to the benefits from the health benefit provider for medical goods dispensed to the consumer;
wherein the retail outlet and the benefit manager are separate entities;
completing and submitting a claim to the health benefit provider for reimbursement for the medical goods dispensed to the consumer;
receiving reimbursement from the health benefit provider for the medical goods dispensed to the consumer; and
making a fixed, periodic payment to the retail outlet for services rendered to the consumer by the retail outlet on behalf of the benefit manager.

2. The method according to claim 1, wherein the step of verifying current eligibility of the consumer includes the step of receiving information from the retail outlet via a pharmacy benefits management (PBM) computer system.

3. The method according to claim 1, further comprising the step of providing the medical goods and services to the consumer at the retail outlet immediately when the consumer requests the medical goods and services while at the retail outlet.

4. The method according to claim 1, further comprising the step of sending the medical goods to the consumer at a time later than when the consumer requests the medical goods and services while at the retail outlet.

5. The method according to claim 1, further comprising the step of requesting payment from the consumer for a share of the amount due pursuant to guidelines of the health benefit provider.

6. The method according to claim 5, wherein the step of requesting payment from the consumer for the share of the amount due is made at a time later than when the consumer requests the medical goods and services while at the retail outlet.

7. The method according to claim 5, wherein the step of requesting payment from the consumer for the share of the amount due is made when the consumer requests the medical goods and services while at the retail outlet.

8. The method according to claim 1, further comprising the steps of receiving an invoice for drop-shipped medical goods from a manufacturer and making payment for the invoice to the manufacturer.

9. The method according to claim 1, further comprising the step of receiving a manufacturer rebate.

10. The method according to claim 1, further comprising the step of the benefit manager obtaining medical goods and directing the medical goods to be located at the retail outlet for distribution to the consumer.

11. The method according to claim 1, further comprising the step of receiving transfer of ownership from the retail outlet for medical goods located at the retail outlet for distribution to the consumer.

12. The method according to claim 11, further comprising the steps of receiving an invoice for the medical goods from the retail outlet and making payment for the invoice to the retail outlet.

13. The method according to claim 1, further comprising the step of making a variable, periodic payment to the retail outlet for services rendered to the consumer by the retail outlet in addition to the fixed, periodic payment.

14. A method of providing medical goods and services to consumers comprising the steps of, in combination:
obtaining eligibility information from a consumer who is presently located at a retail outlet and who desires immediate medical goods and services;
forwarding the eligibility information to a benefit manager for verification of the consumer's eligibility for benefits from a health benefit provider for the medical goods and services;
wherein the benefit manager is a separate entity from the retail outlet;
directing the consumer to make an assignment of the benefits to the benefit manager for the medical goods and services;
forwarding evidence of the assignment to the benefit manager; and
receiving from the benefit manager a fixed, periodic payment for services rendered by the retail outlet on behalf of the benefit manager.

15. The method of claim 14, further comprising the step of providing the medical goods and services to the consumer at the retail outlet while the consumer is present at the retail outlet and requests the medical goods and services.

16. The method of claim 14, further comprising the step of informing the consumer that the medical goods will be sent to the consumer after a period of time.

17. The method according to claim 14, wherein the step of forwarding eligibility information includes the step of forwarding information to the benefit manager via a pharmacy benefits management (PBM) computer system.

18. The method according to claim 14, further comprising the step of the retail outlet requesting payment of a share of a total amount due from the consumer at the time of providing the medical goods and services to the consumer

19. The method according to claim 14, further comprising the step of receiving verification of the consumer's eligibility for benefits from the benefit manager.

20. The method according to claim 14, further comprising the step of obtaining medical goods owned by the benefit manager for distribution to the consumer.

21. The method according to claim 14, further comprising the step of obtaining medical goods owned by the retail outlet for distribution to the consumer.

22. The method according to claim 21, further comprising the step of transferring ownership of medical goods from the retail outlet to the benefit manager prior to dispensing the medical goods to the consumer.

23. The method according to claim 22, further comprising the steps of sending an invoice for the medical goods to the benefit manager and receiving payment for the invoice from the benefit manager.

24. The method according to claim 21, further comprising the step of receiving a variable, periodic payment from the benefit manager for services rendered to the consumer by the retail outlet in addition to the fixed, periodic payment.
